(19) United States
(12) Patent Application Publication
(10) Pub. No.: US 2001/0042424 A1
(43) Pub. Date: Nov. 22, 2001

(54) REDUCED VIBRATION LATHE

(75) Inventors: TERRENCE SHEEHAN, ELMIRA, NY (US); JACEK MIERZEJEWSKI, HORSEHEADS, NY (US); DOUGLAS E. BRACKLEY, HORSEHEADS, NY (US); GARY COMSTOCK, GILLETTE, PA (US)

Correspondence Address: PILLSBURY MADISON & SUTRO LLP, INTELLECTUAL PROPERT GROUP, 1100 NEW YORK AVENUE NW, NINTH FLOOR EAST TOWER, WASHINGTON, DC, 200053918

(73) Assignee: sheehan

(21) Appl. No.: 09/389,052

(22) Filed: Sep. 2, 1999

Related U.S. Application Data
(60) Provisional application No. 60/099,303, filed on Sep. 4, 1998.

(51) Int. Cl. B23B 9/00; B23B 17/00

(52) U.S. Cl. 82/121; 82/149

(57) ABSTRACT

A lathe base assembly is disclosed that decreases vibration and increases thermal stability in a lathe utilizing either a cast iron or composite base. Two separate pairs of rails mounted offset from each other are provided for mounting a secondary spindle and a tool turret, respectively. Vibration from the tool turret caused by the machining operation is thus isolated from the secondary spindle (and vice-versa). If a second tool turret is provided with the lathe, a third separate pair of rails can also be provided for mounting the second tool turret to increase vibration isolation. If a cast iron base is provided, cavities can be provided in the base for filling with a vibration damping material, such as a polymer composite. Alternatively, the base can be constructed from a composite material, and especially a polymer composite.

### CROSS REFERENCE TO RELATED APPLICATIONS

This application incorporates herein by reference U.S. Provisional Application No. 60/099,303 filed Sep. 4, 1998.

### FIELD OF THE INVENTION

The present invention relates to a lathe and more particularly, to a turret lathe having a driven main spindle, secondary spindle (driven or not) and at least one tool turret.

### DESCRIPTION OF THE PRIOR ART

In a traditional lathe, the lathe base is constructed of cast iron. While strong, cast iron bases, because of their inherent metallic structures, are not always adequate by themselves at damping vibrations generated during the machining operations. Reducing or damping vibration in a lathe is important for several reasons. Reducing vibration provides for more precise machining by allowing greater dimensional control. Reduced vibration also provides for improved surface finishes on the machined part and allows faster machining speeds and heavier or deeper cuts. Reduced vibration also increases reliability and tool/machine life and can reduce noise from the machining operation.

In addition, increasing thermal stability of the lathe and tools will also provide for greater dimensional control in the machining operation.

In a traditional lathe having a driven main spindle, a secondary spindle (driven or not) and at least one tool turret, it is known to mount the tool turret and the secondary spindle on the same pair of continuous rails. However, vibration from the machining operation is transmitted from the tool turret to the secondary spindle (and vice-versa) not only through the cast iron base but also through the continuous pair of rails on which both the tool turret and the secondary spindle are directly mounted.

One approach to reducing vibration has been to replace the cast iron base with a base constructed of composite materials, including polymer composites. Hardinge Inc., assignee of the present invention, manufactures a line of lathes utilizing bases constructed from Hardinge's HARCRETE® polymer composite. The polymer composite is cast into the desired shape using molds designed for the specific application. Inserts are cast into the base for mounting rails and other components to the base. Hydraulic or pneumatic tubes and fittings, as well as other types of inserts may be cast into the base as needed. In a lathe base configuration, the HARCRETE® polymer composite is stiffer and more rigid than cast iron and significantly reduces vibration and increases damping as compared to cast iron. The HARCRETE® polymer composite base also has increased thermal stability, exhibiting not only less growth over time than cast iron, but more predictable growth, allowing for easier compensation for changes in the machining process resulting from the growth.

### SUMMARY OF THE INVENTION

The present invention provides a lathe base assembly that decreases vibration and increases thermal stability in a lathe utilizing either a composite or composite reinforced cast iron base. Two separate pairs of rails mounted offset from each other are provided for mounting the secondary spindle and a tool turret, respectively. If a second tool turret is provided with the lathe, a third separate pair of rails can also be provided for mounting the second tool turret. If a cast iron base is provided, cavities can be provided in the base for filling with a vibration damping material, such as a polymer composite. Alternatively, the base can be constructed primarily from a composite material, and especially a polymer composite.

It is therefore an object of the present invention to provide a lathe base assembly that reduces vibration and increase damping in a lathe.

It is also an object of the present invention to provide a lathe base assembly that has increased thermal stability.

It is also an object of the present invention to provide a lathe base assembly having separate pairs of rails for mounting a tool turret and a secondary spindle, respectively, to the lathe base assembly.

It is also an object of the present invention to provide a lathe base assembly having a cast iron or other metal base including at least one cavity for containing a vibration damping substance.

The foregoing and other objects, features, characteristics and advantages of the present invention as well as the methods of operation and functions of the related elements of structure, and the combination of parts and economies of manufacture, will be apparent from the following detailed description and the appended claims, taken in connection with the accompanying drawings, all of which form a part of the specification, wherein like reference numerals designate corresponding parts in the various figures.

### BRIEF DESCRIPTION OF THE DRAWINGS

FIG. 1 is a partial front perspective view of the lathe of the present invention;

FIG. 2 is a partial front perspective view of the lathe base assembly of the present invention with slides mounted;

FIG. 3 is a sectional view of the lathe base assembly taken along section line 3-3 in FIG. 2;

FIG. 4 is a sectional view of an alternative embodiment of the lathe base assembly taken along section line 3-3 in FIG. 2; and

FIG. 5 is a sectional view of an alternative embodiment of the lathe base assembly taken along section line 3-3 in FIG. 2.

### DETAILED DESCRIPTION OF THE INVENTION

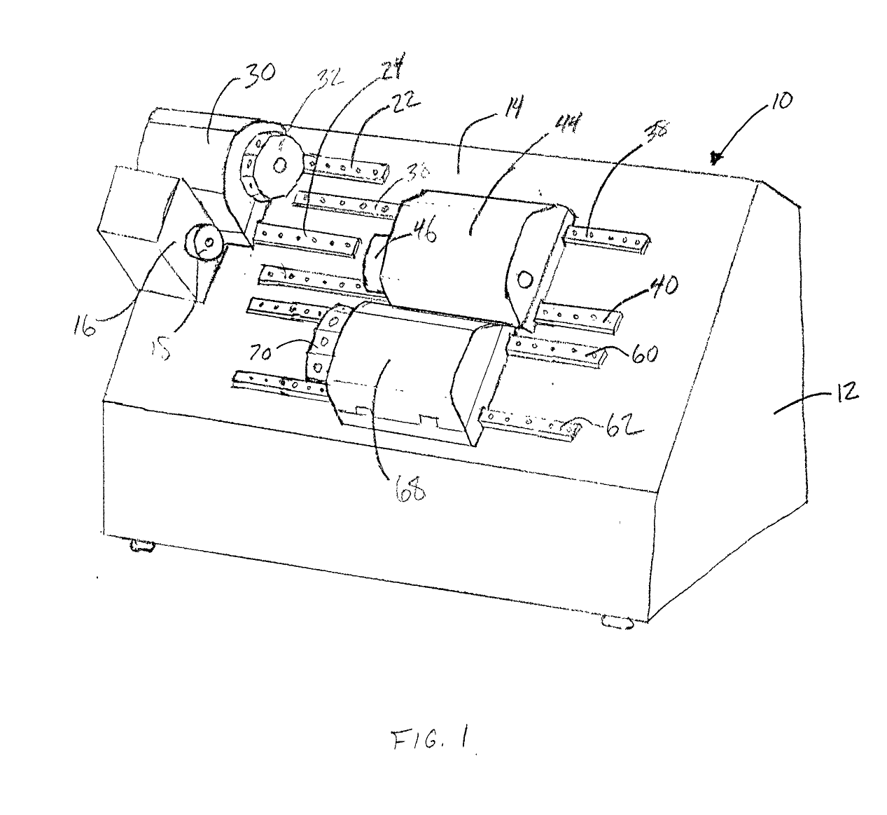

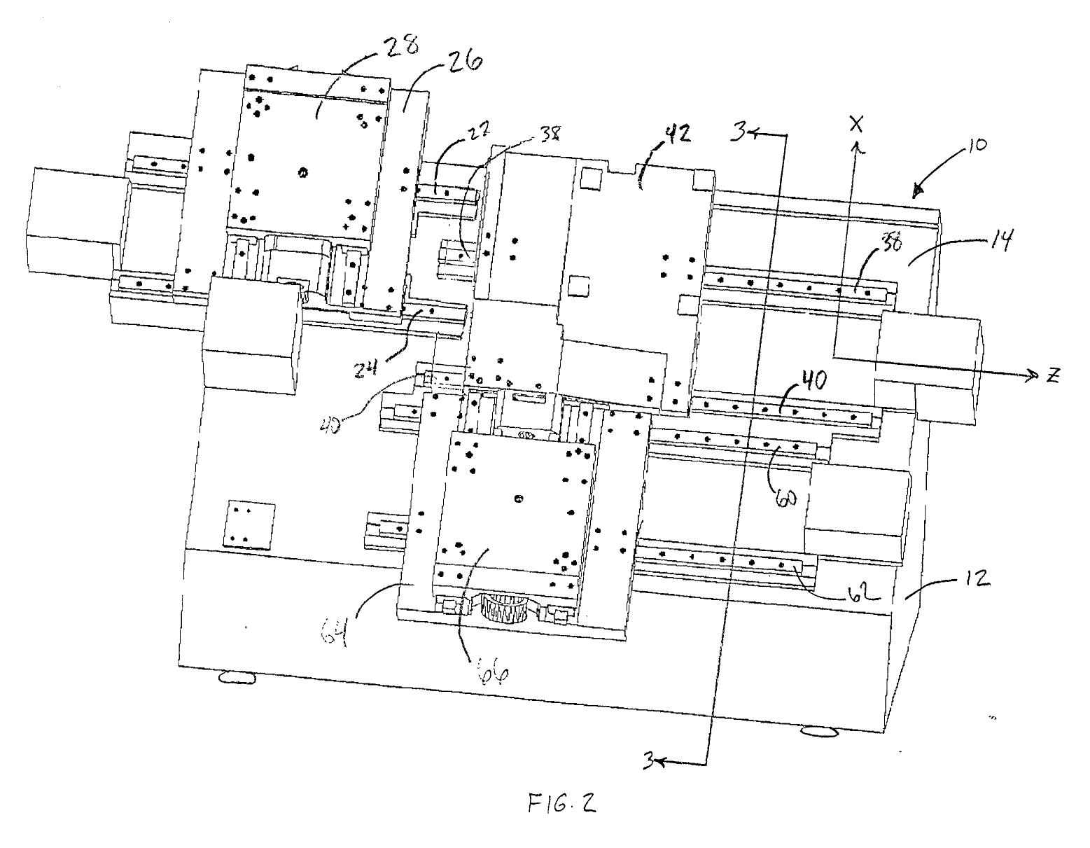

As can best be seen in FIGS. 1 and 2, a turret lathe, generally indicated at 10, includes a base 12. The base 12 can be constructed of metal, usually cast iron. Alternatively, the base can be constructed of a composite material, including a polymer composite (sometimes referred to as a polymer concrete). When considering all the characteristics of the base material, such as dimensional stability, complexity of the base, cost of manufacture, vibration damping, thermal stability, chemical resistance, etc., one or the other (metal vs. composite) may be found to be more suitable for a specific application.

One composite material used for lathe bases is a polymer composition known as HARCRETE®, used by the assignee of the present invention to manufacture lathe bases for certain models of lathes. HARCRETE® is a castable composite including approximately 93% crushed hard stone thoroughly blended with an epoxy binder. A mold constructed specifically for a particular lathe base is prepared. Inserts can be added to the mold before the casting process to provide a ready-for-assembly casting. Such inserts can include mounting bosses, threaded inserts, hydraulic and pneumatic fittings, stiffeners, etc. Crushed stone is thoroughly blended with a specified amount of epoxy binder and poured into the prepared mold. The mold is mounted to a vibration table and vibrated under controlled frequency and amplitude to consolidate the mixed aggregate and epoxy binders, to increase the density of the composition and to produce a void-free, quality surface. The cast is cured for 3-5 days, whereupon the cast base is ready for final finishing and assembly.

As compared with cast iron bases, lathes built with HARCRETE® have exhibited several times greater damping capacity with decreased vibration, thereby allowing greater tool life, improved workpiece surface finish and greater dimensional control. The HARCRETE® polymer composite base also has increased thermal stability, exhibiting not only less growth over time than cast iron, but more predictable growth, allowing for easier compensation for changes in the machining process resulting from the growth.

Other polymer composites are also available, including Anocast® by the Anorad Corporation, Granitan® by Stüder, or PolyCast® by Philadelphia Resins.

As is common in the industry, the base 12 includes a slanted bed surface 14, although the present invention can also be applied to a lathe having a horizontal bed surface. A main spindle 16 is conventionally mounted to the base 12 and includes a work holding device 18 for mounting a workpiece in the lathe 10. A pair of rails 22 and 24 are mounted to the bed surface 14 parallel to a z-axis of the lathe. A first tool turret slide 26 is mounted to the pair of rails and is movable in the direction of the z-axis. A first tool turret cross-slide 28 is conventionally mounted to the slide 26 and is movable in a direction parallel to an x-axis of the lathe. A first tool turret 30 is mounted to the cross-slide 28 and through the operation of slide 26 and cross-slide 28, is movable parallel to both the z-axis and the x-axis. The first tool turret 30 is of a known and conventional type and includes the customary controls, drives, lead screws, connections and indexing functions, as appropriate, and is capable of supporting and operating both stationary and live tooling. The desired tooling is mounted in a turret tool top plate 32 in the conventional manner. The first tool turret 30 can be utilized to perform machining operations on a workpiece conventionally mounted in work holding device 18 of main spindle 16.

A separate pair of rails 38 and 40 are also mounted to the bed surface 14 parallel to the z-axis of the lathe. A secondary spindle slide 42 is mounted to the pair of rails and is movable in the direction of the z-axis. A secondary spindle 44 is mounted to the slide 42 and through the operation of slide 42, is movable parallel to the z-axis. The secondary spindle 44 is of a known and conventional type and includes the customary controls, drives, lead screws, connections and functions, as appropriate, and is capable of operating in both a driven and an undriven mode. FIG. 1 shows the secondary spindle in the driven mode with a work holding device 46 mounted to the secondary spindle 44 for holding a workpiece.

Rails 38 and 40 are offset from rails 22 and 24 in the direction of the x-axis, thereby allowing the separate pairs of rails to overlap one another. As can be seen in the FIGS., a portion of rail 38 lies between rails 22 and 24, while a portion of rail 24 lies between rails 38 and 40. This overlapping of the pairs of rails gives a greater overall range of movement in the z-direction for both the first tool turret 30 and the secondary spindle 44 than would otherwise be available if there was no overlapping of the rail pairs. The overlapping also allows the use of first tool turret 30 to perform machining operations on a workpiece conventionally mounted in work holding device 46 of secondary spindle 44, as well as on a workpiece mounted in work holding device 18.

The separation of the rails also serves to reduce vibration transmitted from the first tool turret 30 to the secondary spindle 44 during a machining operation, and vice-versa. This is a result of eliminating a direct path of vibration transmission between the two as would exist if the first tool turret 30 and the secondary spindle 44 were mounted to the lathe 10 through the same continuous pair of rails, as is done conventionally. The vibration reduction is further enhanced by use of the separated rails if the lathe base 12 has vibration-damping qualities. This may be provided, as discussed above, by use of a base constructed of vibration damping materials, such as polymer composites.

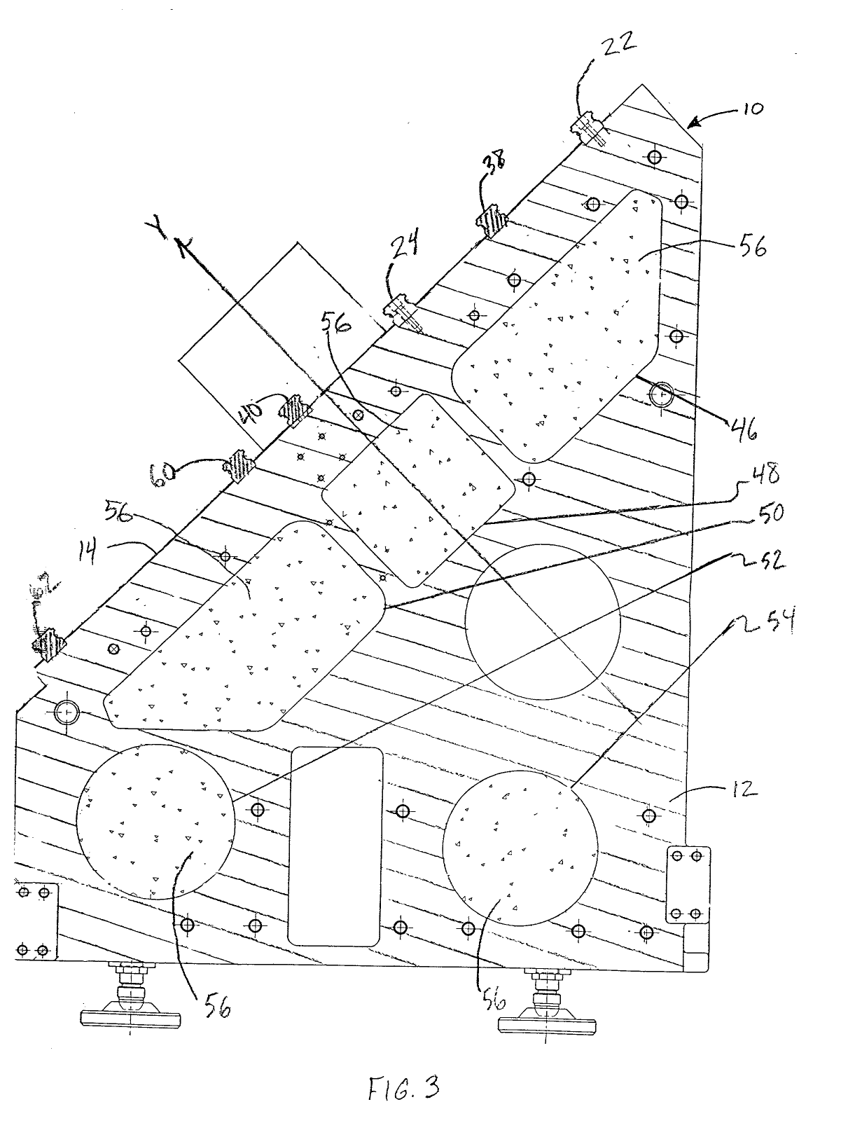

Alternatively, in a lathe having a base constructed primarily of cast iron or other metal, the vibration-damping qualities of the base can be enhanced by the addition of vibration-damping materials to the base. As is shown in FIG. 3, cavities 46, 48, 50, 52 and 54 are provided in the lathe base 12 and can be filled with a vibration-damping material 56, such as HARCRETE® or another polymer composite. In the preferred embodiment utilizing a cast iron base, the cavities extend through a substantial portion of the length of the lathe base. In most instances, it is desirable to strategically size and locate the vibration-damping material filled cavities to maximize rigidity and torsional stiffness. The size, shape and location of the cavities can be optimized through Finite Element Analysis to maximize the vibration-damping characteristics of the lathe base when the cavities are at least partially filled with a vibration-damping material. The results of the Finite Element Analysis, and thus the size, shape and location of the cavities, will depend on the specific configuration of the lathe base, the base material, and the damping material, as well as the desired level of damping.

While the embodiment shown in FIG. 3 shows several cavities filled with a vibration-damping material, improved vibration-damping and stiffness characteristics can also be obtained by filling one or more of the cavities at least partially with a vibration-damping material. In the preferred embodiment, the desired cavities are filled with the vibration-damping material and cured prior to the final machining, if necessary, of the lathe base. This allows the final machining of the lathe base to be performed under improved vibration-damping and stiffness characteristics and results in improved tolerances and surface finishes of the machined lathe base. Further, although the greatest benefit in filling lathe base cavities with a vibration-damping material can be found in lathes having cast iron or other metal lathe bases, improved vibration-damping characteristics can also be obtained in lathe bases constructed of composite materials by at least partially filling one or more cavities located in such lathe bases with a vibration-damping material.

The filling of the cavity with the vibration-reducing material can also increase the rigidity and torsional stiffness of the lathe base. Therefore, the greater the portion of the cavity or cavities that is filled with the vibration-damping material, the greater the increase in rigidity and torsional stiffness that can be expected.

To maximize the stiffness and vibration-damping characteristics of the lathe base, it is important to maximize the bond integrity (either adhesive or molecular) and/or surface contact between the vibration-damping material and the base. The preferred method for achieving such bond integrity and surface contact is to cast the vibration-damping material directly into the desired cavities under controlled conditions to prevent separation of the vibration-damping material from the surfaces of the cavities. While less preferred, improved vibration-damping of the lathe base, as compared to a standard lathe base, can nonetheless be achieved with lower integrity bonds and reduced surface contact between the vibration-damping material and the lathe base.

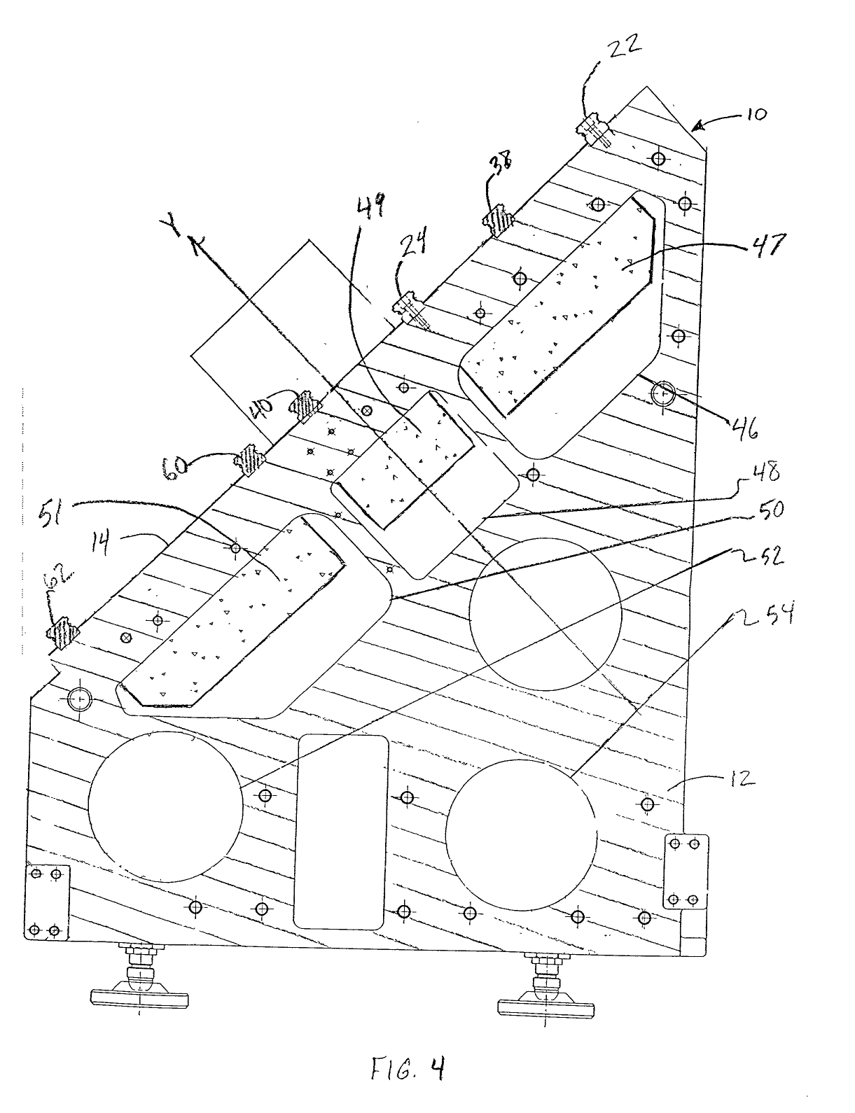

For instance, the damping characteristics of the lathe base can also be improved by mounting blocks of vibration damping material or viscous dampers such as shear tubes to the lathe base. FIG. 4 shows such an alternative embodiment, where blocks of vibration-damping material 47, 49 and 51 are mounted respectively in cavities 46, 48 and 50. Although the expected increase of the vibration-damping characteristics will likely be less than if the vibration-damping material is directly cast into cavities in the lathe base, improved vibration-damping characteristics can still be achieved in this manner. The blocks can be mounted by shrink-fit, with bolts, clamps and/or adhesives, or in any other known manner. The greater the bond integrity and surface contact between the blocks and the lathe base, the greater the vibration-damping and stiffness characteristics that can be expected. The blocks can be constructed of the vibration-damping materials discussed above or any other vibration-damping materials. The respective blocks may be constructed as unitary blocks or can be constructed in multiple pieces, especially to ease installation. The use of the mounted blocks can also be combined with the cast-in vibration damping materials discussed above. Further, different combinations of different vibration-damping materials in a lathe base can be utilized to provide specialized results dictated by the application.

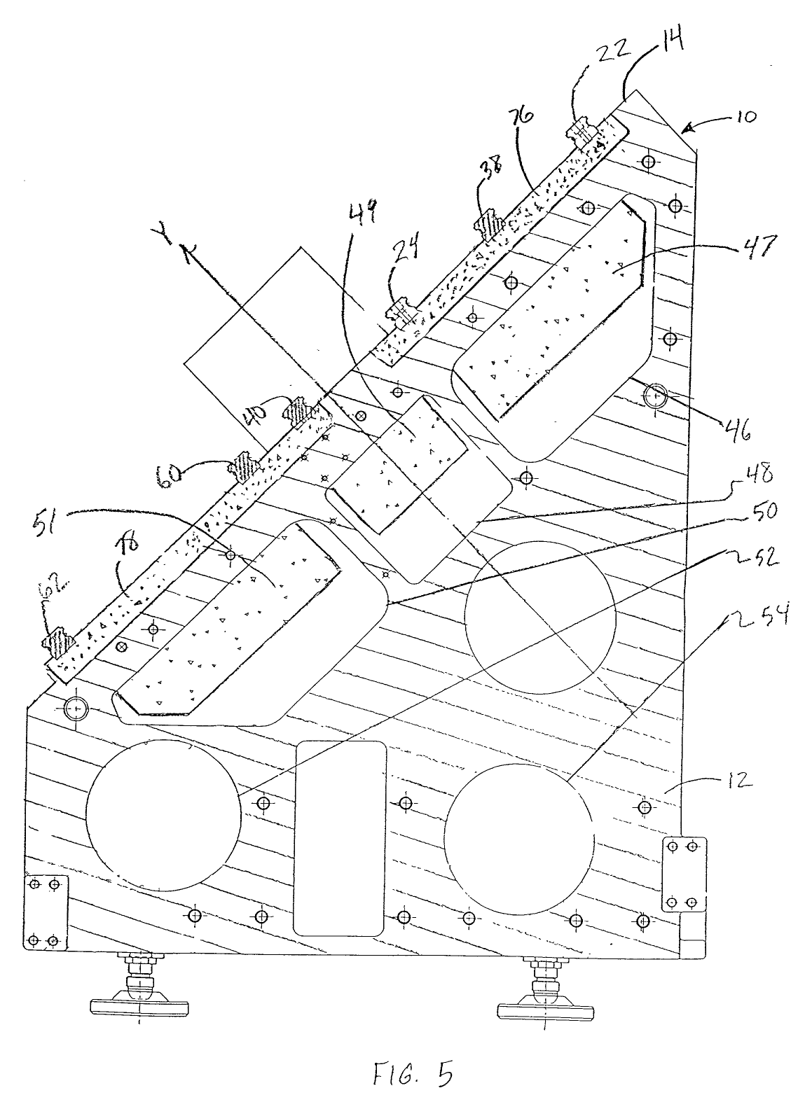

Additionally, one or more pads of vibration-damping material can be mounted between the slide rails and the lathe base to isolate the slide rails from the lathe base and thereby increase vibration damping in the lathe. FIG. 5 shows one such an embodiment where pads 76 and 78 are positioned between the slide rails and the lathe base. In such an embodiment, the vibration-damping is increased if there is no direct connection between the slide rails and the lathe base, but instead, the slide rails are mounted to the vibration-damping block and the vibration-damping block is connected to the lathe base. Alternatively, the vibration-damping pad or pads can be cast into a cavity or cavities provided in the lathe bed surface, with the necessary inserts and stiffeners, and the slide rails mounted to the cast-in vibration-damping pads.

Thus, when the separate rails are combined with a vibration-damping lathe base, as with a lathe base constructed of a vibration-damping material or in a metal lathe base incorporating supplemental additions of vibration-reducing materials, the overall vibration-damping and stiffness characteristics of the lathe are enhanced, with the expected results described above.

A second tool turret can also be provided on the lathe. In that case, another pair of rails 60 and 62 are mounted to the bed surface 14 parallel to the z-axis of the lathe. A second tool turret slide 64 is mounted to the pair of rails and is movable in the direction of the z-axis. A second tool turret cross-slide 66 is conventionally mounted to the slide 64 and is movable in a direction parallel to an x-axis of the lathe. A second tool turret 68 is mounted to the cross-slide 66 and through the operation of slide 64 and cross-slide 66, is movable parallel to both the z-axis and the x-axis. The second tool turret 68 is of a known and conventional type and includes the customary controls, drives, lead screws, connections and indexing functions, as appropriate, and is capable of supporting and operating both stationary and live tooling. The desired tooling is mounted in a turret tool top plate 70 in the conventional manner. The second tool turret can be utilized to perform machining operations on a workpiece mounted in work holding device 18 of main spindle 16, as well as on a workpiece mounted in work holding device 46 or secondary spindle 44.

If desired, any of the first tool turret 30, the secondary spindle 44 or the second tool turret 68 can also be provided with a known mechanism for providing movement of the respective apparatus parallel to a y-axis of the lathe, which can be seen in FIG. 3 and which runs perpendicular to the lathe bed surface 14.

While this invention has been described in connection with what is presently considered to be the most practical and preferred embodiment, it is to be understood that it is capable of further modifications and is not to be limited to the disclosed embodiment, and this application is intended to cover any variations, uses, equivalent arrangements or adaptations of the invention following, in general, the principles of the invention and including such departures from the present disclosure as come within known or customary practice in the art to which the invention pertains, and as may be applied to the essential features hereinbefore set forth and followed in the spirit and scope of the appended claims.

We claim:

1. A lathe comprising:
a base;
a driven main spindle mounted to the base;
a first tool turret rail assembly mounted to the base generally parallel to a z axis of the base;
a first tool turret assembly movably mounted on the turret tool rail assembly for movement along the z-axis;
a secondary spindle rail assembly separate from the tool turret rail assembly mounted to the base generally parallel to the z axis of the base; and
a secondary spindle movably mounted on the secondary spindle rail assembly for movement along the z-axis.

2. A lathe as in claim 1 and further comprising:
a second tool turret assembly mounted to the base.

3. A lathe as in claim 2, wherein the second tool turret assembly is movably mounted to a second tool turret rail assembly mounted to the base.

4. A lathe as in claim 1, wherein the base includes a vibration-damping substance attached to the base for decreasing vibrations in the lathe.

5. A lathe as in claim 4, wherein the vibration-damping substance is cast into a cavity in the base.

6. A lathe as in claim 4, wherein the vibration-damping substance is mounted in a cavity in the base.

7. A lathe as in claim 1, wherein the base is constructed of a polymer composite.

8. A lathe as in claim 4, wherein the base is constructed of a polymer composite.

9. A lathe as in claim 4, wherein the base is constructed of metal.

10. A lathe as in claim 1, wherein the first tool turret rail assembly and the secondary spindle rail assembly are offset from each other along an x axis of the lathe.

11. A lathe as in claim 10, wherein a portion of the first tool turret rail assembly interstitially overlaps with a portion of the secondary spindle rail assembly.

12. A lathe as in claim 11, wherein the first tool turret rail assembly includes two parallel rails and the secondary spindle rail assembly includes two parallel rails.

13. A lathe as in claim 1, wherein the secondary spindle is driven.

14. A lathe as in claim 1, wherein the first tool turret assembly is constructed and arranged to machine a workpiece mounted to the main spindle and a workpiece mounted to the secondary spindle.

15. A lathe as in claim 1, wherein the second tool turret assembly is constructed and arranged to machine a workpiece mounted to the main spindle and a workpiece mounted to the secondary spindle.
